(19) United States
(12) Patent Application Publication
(10) Pub. No.: US 2008/0288517 A1
(43) Pub. Date: Nov. 20, 2008

(54) DOCUMENT INFORMATION MANAGEMENT APPARATUS, PROGRAM AND METHOD FOR ACQUIRING INFORMATION RELATED TO A DOCUMENT

(75) Inventor: Noriyuki KOMAMURA, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 12/166,667

(22) Filed: Jul. 2, 2008

Related U.S. Application Data
(62) Division of application No. 10/915,425, filed on Aug. 11, 2004.

(51) Int. Cl. G06F 17/30

(52) U.S. Cl. 707/100; 707/E17.008

(57) ABSTRACT

A document information management apparatus is obtained which is capable of acquiring relevant information desired by a user as well as obtaining user's desired information created from the relevant information thus acquired in an efficient and quick manner. The apparatus includes a document handling part (3) capable of handling documents, a monitor part (5) that detects when the state of a document handled in the document handling part (3) changes, relevant information acquisition sections (7, 8) that acquire desired information related to the document, and a relevant information acquisition part setting part (6) capable of setting, based on a change in the state of the document detected by the monitor part (5), the relevant information acquisition sections (7, 8) that acquire the desired information related to the document.

### CROSS REFERENCE TO RELATED APPLICATION

The present application is a Divisional of U.S. application Ser. No. 10/915,425, filed Aug. 11, 2004, the entire contents of which are incorporated herein by reference.

### BACKGROUND OF THE INVENTION

1. Field of the Invention

The present invention relates to a document information management apparatus and a document information management program capable of acquiring and managing information related to documents so as to manage the information related to documents.

2. Description of the Related Art

Conventionally, as a document information management apparatus, there has hitherto been known one which monitors a user's operation input from an input device by means of an operation monitoring part, extracts the creation, update and reference processing of documents as well as document output processing such as transmission, printing, etc., and records the name of each document to be operated, the time point of occurrence of the operation, the identifier of a user who performed the operation, the user identifier at the transmission destination, etc., in an operation history storage part as operation history or records (see, for example, Japanese patent application laid-open No. 2000-172696).

This document information management apparatus further analyzes, in a history cluster creation part, the operation history accumulated in the operation history storage part, divides the operation history into groups of small history segments, for example, which are arranged in time series within a prescribed time range according to users, and records the operation history groups thus formed after such division in a cluster storage part as clusters.

In the conventional technique, however, with reference to the collection of relevant information of a document, there exist no configuration that enables a user to acquire his or her desired relevant information upon making use of the relevant information including the attribute information of the document, and hence the creation of user's desired information based on the relevant information is not carried out either. In addition, there is a further problem that the creation of the desired information based on the relevant information is not carried out each time the relevant information is obtained, so the relevant information has already become old, thus making it impossible for the user to quickly obtain the latest information as desired on the basis of the history, etc.

### SUMMARY OF THE INVENTION

The present invention has been made to solve the problems as referred to above, and is intended to provide a document information management apparatus and a document information management program which are capable of acquiring relevant information desired by a user as well as obtaining user's desired information created from the relevant information thus acquired in an efficient and quick manner.

In order to solve the above-mentioned problems, in one aspect, the present invention resides in a document information management apparatus for acquiring information related to a document so as to manage the document relevant information, the apparatus comprising: a document handling part capable of handling documents; a monitor part that detects when the state of a document handled in the document handling part changes; an acquisition information setting part capable of setting desired information related to the document; and a relevant information acquisition part that acquires desired information set in the acquisition information setting part based on a change in the state of the document detected by the monitor part.

In another aspect, the present invention resides in a document information management apparatus for acquiring information related to a document so as to manage the document relevant information, the apparatus comprising: a document handling part capable of handling documents; a monitor part that detects when the state of a document handled in the document handling part changes; a relevant information acquisition part that acquires desired information related to the document; and a relevant information acquisition part setting part capable of setting, based on a change in the state of the document detected by the monitor part, the relevant information acquisition part that acquires desired information related to the document.

In a further aspect, the present invention resides in a document information management apparatus for acquiring information related to a document to manage it as document information, the apparatus comprising: a transmission relevant information acquisition part that acquires information related to a document sent from an apparatus handling the document; and a relevant information analysis part that analyzes the information related to the document acquired by the transmission relevant information acquisition part at prescribed timing related to the timing at which the information is acquired based on the information.

In a still further aspect, the present invention resides in a document information management program for making a computer perform acquiring information related to a document so as to manage the document relevant information, the program comprising: an acquisition information setting step of setting desired information related to a document; and a state change detection step of detecting when the state of a document changes; and a relevant information acquisition step of acquiring the desired information set in the acquisition information setting step based on a change in the state of the document detected in the state change detection step.

In a yet further aspect, the present invention resides in a document information management program for making a computer perform acquiring information related to a document so as to manage the document relevant information, the program adapted to make the computer perform: an acquisition function setting step of setting at least one relevant information acquisition function to acquire desired information related to a document; a state change detection step of detecting when the state of the document changes; and a relevant information acquisition step of acquiring information related to the document by means of the at least one relevant information acquisition function set in the acquisition function setting step based on a change in the state of the document detected in the state change detection step.

In a further aspect, the present invention resides in a document information management program adapted to be executed by a computer of a document information management apparatus for acquiring and managing information related to a document, the program serving to make the computer perform: a transmission relevant information acquisition step of acquiring information related to a document sent from an apparatus handling the document; and a relevant information analysis step of analyzing the information related to the document acquired in the transmission relevant information acquisition step at prescribed timing related to the timing at which the information is acquired.

### BRIEF DESCRIPTION OF THE DRAWINGS

FIG. 1 is a block diagram showing the basic structure of a document information management apparatus.

FIG. 2 is an overall configuration view of a document information management system according to one embodiment of the present invention.

FIG. 3 is a flow chart showing the operation of a relevant information acquisition part (relevant information acquisition functions) setting part.

FIG. 4 is a flow chart showing the flow of setting in a acquisition information setting screen.

FIG. 5 is one example of the acquisition information setting screen.

FIG. 6 is a flow chart showing the flow of operation to acquire document relevant information in a first document information management apparatus.

FIG. 7 is a flow chart showing the flow of operation to acquire document relevant information in a second document information management apparatus.

FIG. 8 is one example of a storage format in a management part.

FIG. 9 illustrates “the numbers of prints” as one example of a data table managed in the management part.

FIG. 10 illustrates “users” as one example of a data table managed in the management part.

FIG. 11 illustrates “weathers” as one example of a data table managed in the management part.

FIG. 12 is a flow chart showing the flow of operation until a request part acquires necessary information.

FIG. 13 illustrates, as one concrete example of an information request method, one type thereof in which certain pieces of information are selected and displayed from attribute information names.

FIG. 14 illustrates, as one concrete example of an information request method, another type thereof in which attribute information names and their contents are displayed in a list at the same time.

### DESCRIPTION OF THE PREFERRED EMBODIMENT

Now, a preferred embodiment of the present invention will be described below in detail while referring to the accompanying drawings.

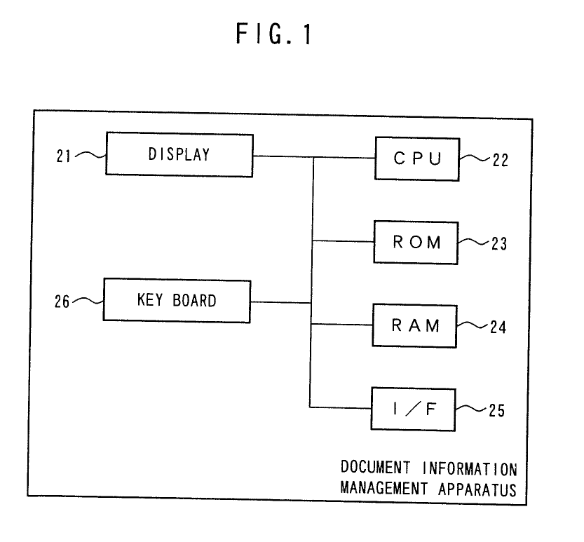

FIG. 1 is a block diagram that shows the basic configuration of a document information management apparatus according to one embodiment of the present invention. The document information management apparatus in FIG. 1 includes a display 21 for displaying documents, operations, etc., a CPU (computer) 22 in charge of control, a ROM (Read Only Memory) 23 serving as a storage part, a RAM (Random Access Memory) 24 also serving as a storage part, an interface 25, and a keyboard 26 through which an input operation is made by a user.

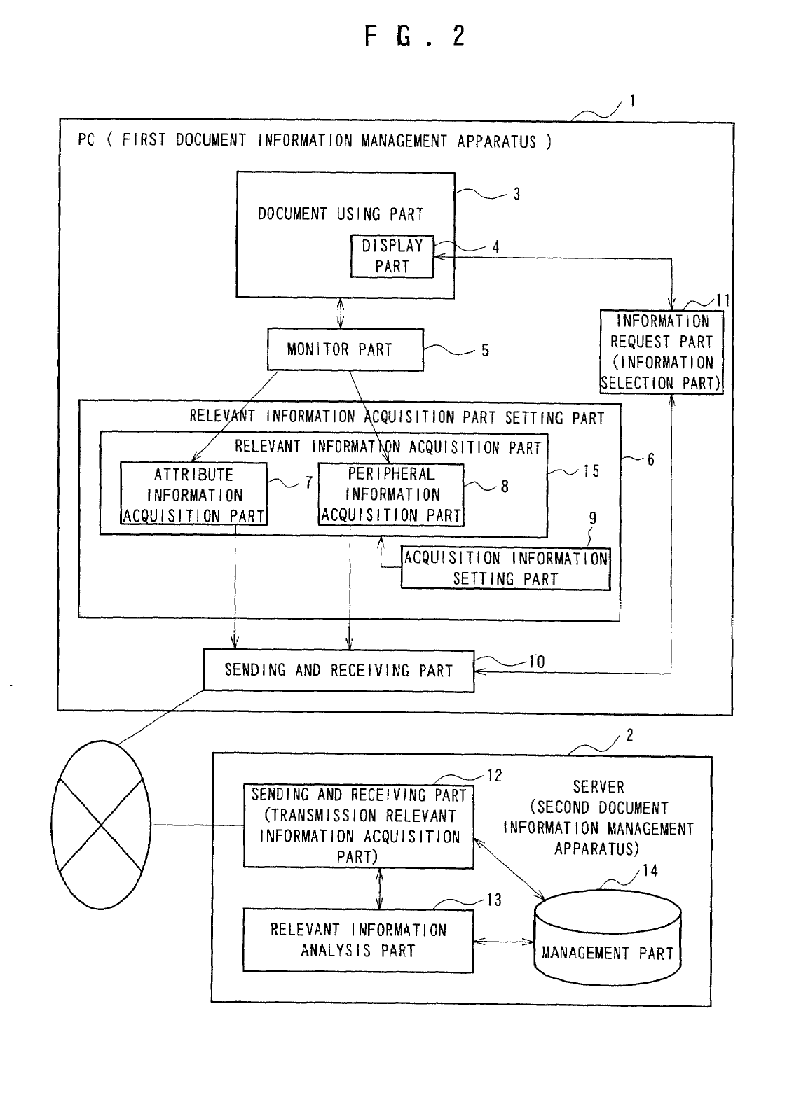

FIG. 2 shows the functional block diagram of a document information management system provided with a first document information management apparatus and a second document information management apparatus which are respectively constructed by using the basic configuration illustrated in FIG. 1.

The document relevant information management system shown in FIG. 2 includes the first document information management apparatus 1 such as a PC, which is on a client side, and the second document management apparatus 2 such as a server, which is on a management device side.

The first document information management apparatus 1 includes a document using part 3 (corresponding to a document handling part of the present invention) for providing an environment in which a user or system can use documents, a monitor part 5 configured to cooperate with an OS (operation system) for monitoring access to documents at all times so as to detect when there takes place a change in the state of each document, a relevant information acquisition part setting part 6 capable of setting a relevant information acquisition part (relevant information acquisition functions) 15, which serves to acquire relevant information of each document, in accordance with a change in the state of the document detected by the monitor part 5, a sending and receiving part 10 for receiving the information acquired by the relevant information acquisition part 15 set by the relevant information acquisition part setting part 6, and sending it to the second document information management apparatus 2, an information request part (information selection part) 11 for acquiring relevant information of a document requested by the user or system.

Here, note that the information request part 11 may be configured in such a manner that it is connected to the outside of the first document information management apparatus 1 through a network or the like.

The relevant information acquisition part 15 includes, for example, an attribute information acquisition section (attribute information acquisition functions) 7 that is configured by setting modules for acquisition of individual pieces of attribute information (e.g., installing programs) so as to acquire a variety of kinds of attribute information desired by the user, and a peripheral information acquisition section (peripheral information acquisition functions) 8 that is configured by setting modules for acquisition of individual pieces of peripheral information (e.g., installing programs) so as to acquire a variety of kinds of peripheral information desired by the user.

The modules constituting the attribute information acquisition section 7 cooperate with the OS to acquire, based on the detection timing of the monitor part 5, the attribute information that can be detected by the OS, such as for example the contents of operations changed by the user or the system (e.g., moving, activating or printing a document, or terminating the use of a document, etc.), the unique or specific information of a document (e.g., title, full path, creation date, etc.). Specifically, the modules corresponding to those pieces of attribute information which the user wants to acquire, among the plurality of pieces of attribute information, are set as the relevant information acquisition sections by the relevant information acquisition part setting part 6.

Also, the peripheral information acquisition section 8 acquires, based on the detection timing of the monitor part 5, peripheral information (e.g., weather when the document is used, the traffic quantity of the network when the document is used, etc.,), which is information other than the attribute information, through the sending and receiving part 10.

Specifically, the modules corresponding to those pieces of peripheral information which the user wants to acquire, among the plurality of pieces of peripheral information, are set as the relevant information acquisition sections by the relevant information acquisition part setting part 6.

Moreover, in this embodiment, in consideration that the user wants to further limit, with respect to the information acquisition sections 7, 8 that have already been set in the relevant information acquisition part setting part 6, the information to be acquired by the attribute information acquisition section 7 and the peripheral information acquisition section 8, provision is made for an acquisition information setting part 9 capable of setting in advance the information (desired information) to be acquired by these information acquisition sections 7, 8 in a limitative manner. With such provision, according to this embodiment, the individual information acquisition sections 7, 8 can be set in accordance with the relevant information desired by the user as acquisition information, and at the same time can be further limited from among those pieces of relevant information so as to obtain desired acquisition information.

The second document information management apparatus 2 includes a sending and receiving part (transmission relevant information acquisition part) 12 for receiving and acquiring the document relevant information sent from the first document information management apparatus 1, a relevant information analysis part 13 for analyzing the document relevant information, which has been acquired by the transmission relevant information acquisition part 12, and the information managed up to that time in combination, and a management part 14 for managing the document relevant information.

Hereinafter, reference will be made to the operation of this embodiment.

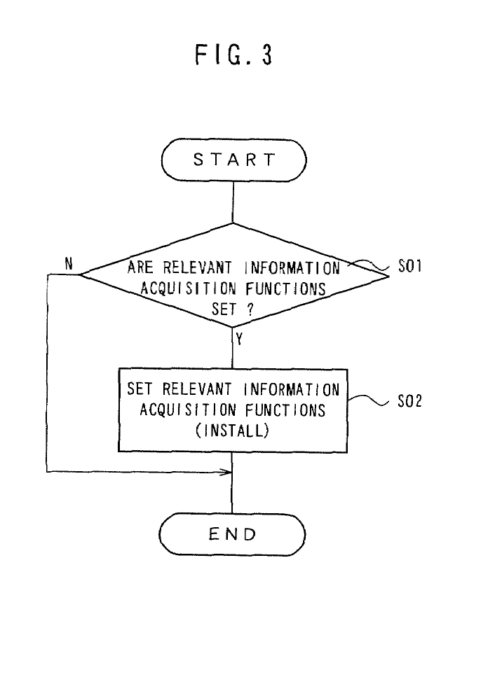

First of all, the setting operation in the relevant information acquisition part setting part 6 will be described while using FIG. 3.

When using this apparatus, the user first sets the relevant information acquisition part (functions) 15 (i.e., the attribute information acquisition section 7 and the peripheral information acquisition section 8) so as to acquire the above-mentioned relevant information such as attribute information, peripheral information, etc. The first document information management apparatus determines, based on an operation of the user, whether the user's operation is an operation of setting the relevant information acquisition part 15 (step S01). When it is a setting operation (step S01, Y), the setting processing of the relevant information acquisition part 15 is performed (step S02). This is carried out by installing acquisition functions (programs) thereof for example.

When acquisition parts for all the desired pieces of relevant information are provided (or set) in advance, the setting of the relevant information acquisition part 15 can be omitted, and in that case, when the user particularly limits acquisition information to the desired relevant information alone, a selection setting operation to be described later is carried out.

Thus, when the setting of the relevant information acquisition part is completed, the user can then further selectively set his or her desired relevant information from among the plurality of pieces of relevant information that can be acquired by using these acquisition sections.

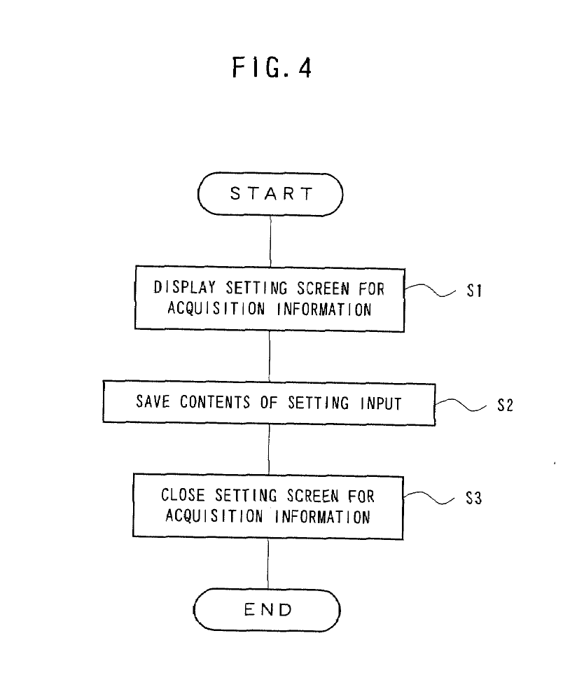

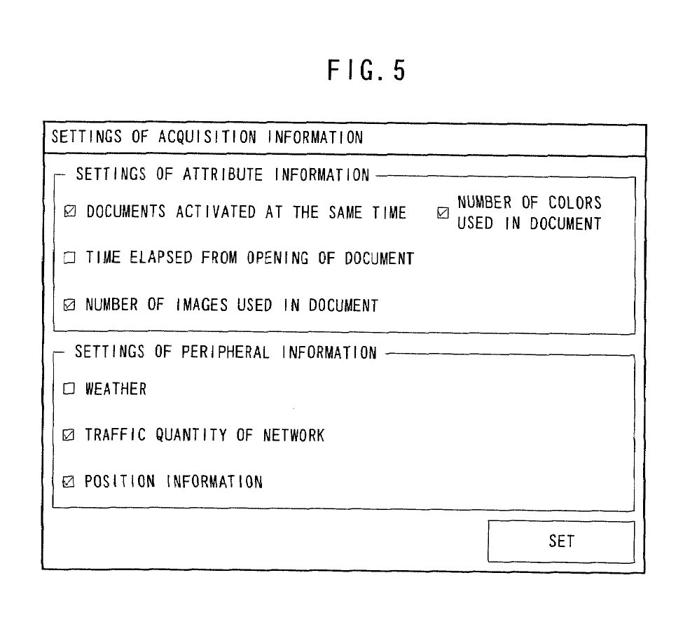

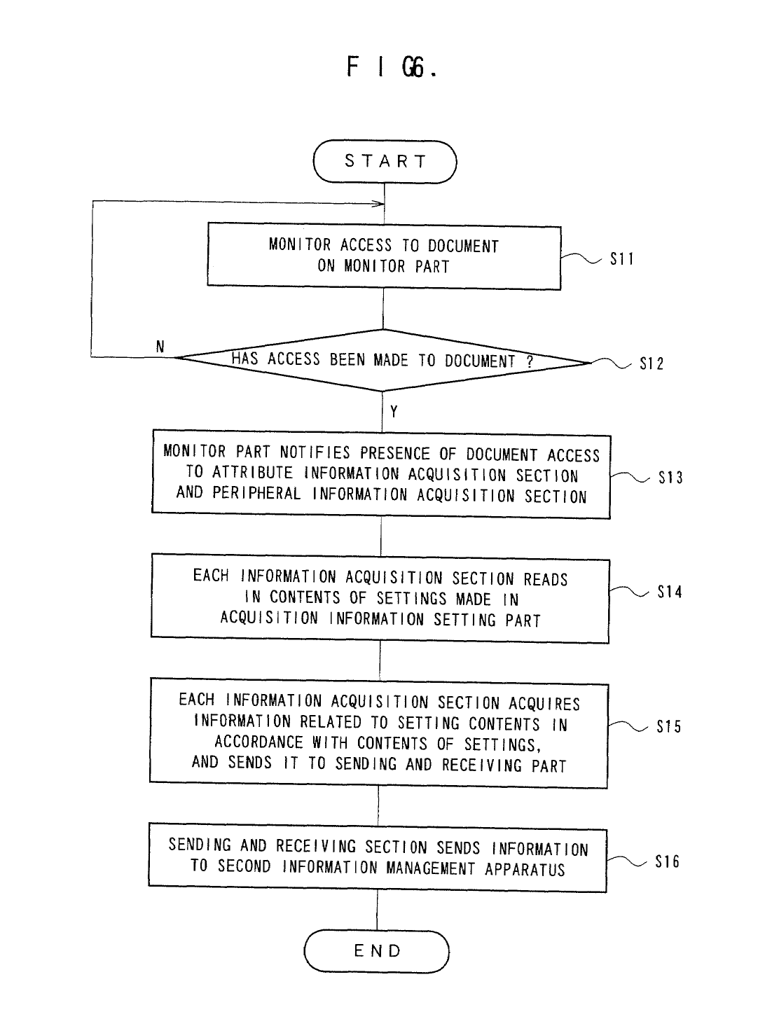

Here, note that such a selective setting can be omitted, and in that case, all the acquisition sections, having been set as the relevant information acquisition part, operate so that all the pieces of relevant information that can be acquired by the individual acquisition sections are obtained. Specifically, as shown in FIG. 4, a setting screen of the acquisition information like FIG. 5 is displayed on the display section 4 in the document using part (S1). Then, the user selects items for setting conditions necessary for the user. (In FIG. 5, “documents to be activated at the same time”, “the number of colors used in the document concerned” and “the number of images used in the document concerned” are selected as settings for desired attribute information, and “the number of traffics of the network” and “position information” are selected as settings for peripheral information.) Thereafter, a set button is pressed. Thus, when the operation of setting the desired pieces of relevant information has been performed by the user, the acquisition information setting part 9 saves or stores the contents of the settings thus input (S2). The setting screen for the acquisition information is closed, and the setting of the acquisition information is terminated (S3). According to the above method, it is possible to set the attribute information acquisition section 7 and the peripheral information acquisition section 8 in such a manner that only those pieces of relevant information which are needed (desired) by the user can be acquired. Subsequently, reference will be made to an operation of acquiring document relevant information in the first document information management apparatus while using a flow chart in FIG. 6.

The monitor part 5 always monitors the presence or absence of access to any document by an operation from a user or the system in the document using part 3 (S11), and determines whether there has been made an access to a certain document (S12). When no access has been made (step S12, N), the monitor part 5 continues monitoring (S11), whereas when an access has been made (step S12, Y), the monitor part 5 notifies the presence of the access to the document to the attribute information acquisition section 7 and the peripheral information acquisition section 8 (S13).

In this case, the monitor part 5 notifies the contents of the operations (e.g., using, activating, printing, terminating the use, etc.) and the specific or unique information of the document (e.g., title, full path, creation date, etc.) in combination.

Upon receipt of this notification, the attribute information acquisition section 7 and the peripheral information acquisition section 8 acquire, among the information that can be acquired in each function, relevant information on those pieces of information which have been set by the acquisition information setting part. For example, the attribute information acquisition section 7 acquires only those pieces of information which are attribute information having functions (set functions) able to be acquired on its own and which have been set in the acquisition information setting part 9, among a variety of kinds of attribute information of the document (e.g., a plurality of pieces of attribute information such as the number of characters, the number of lines, the number of objects and the number of colors in the document, the number of corrections made from the start or activation, and so on) related to the OS (operation system), the system or the like (S14).

Also, the peripheral information acquisition section 8 acquires only those pieces of information which are peripheral information having functions (set functions) able to be acquired on its own and which have been set in the acquisition information setting part 9, among a variety of pieces of peripheral information (e.g., a plurality of pieces of peripheral information such as the weather at the time when the document is used, the traffic quantity of the network, etc.) other than the attribute information at the time when the document is operated (S14).

Each of the information acquisition sections sends the thus acquired pieces of information to the sending and receiving part 10 (S15).

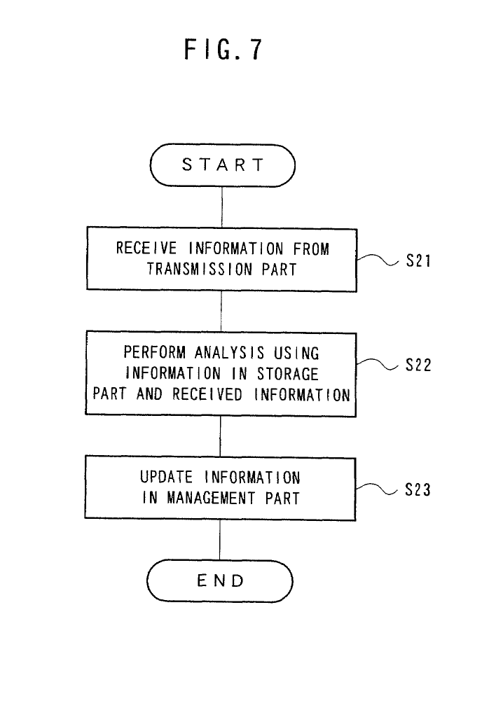

The sending and receiving part 10 sends the information thus received to the second document information management apparatus 2 (S16). Next, reference will be made to the flow of operation from the time when the acquired information is analyzed in the second document information management apparatus 2 until the time when the result of the analysis is saved or stored in the management part, while using a flow chart in FIG. 7.

The sending and receiving part 12 in the second document information management apparatus 2 receives the document relevant information from the sending and receiving part 10 in the first document information management apparatus (S21). The relevant information analysis part 13 makes an analysis using the document relevant information thus sent thereto and the information that has been managed up to that time by the management part 14 (S22), and updates the information in the management part 14 after the analysis (S23). The relevant information analysis part 13 makes an analysis each time information is sent thereto, and updates the information in the management part 14.

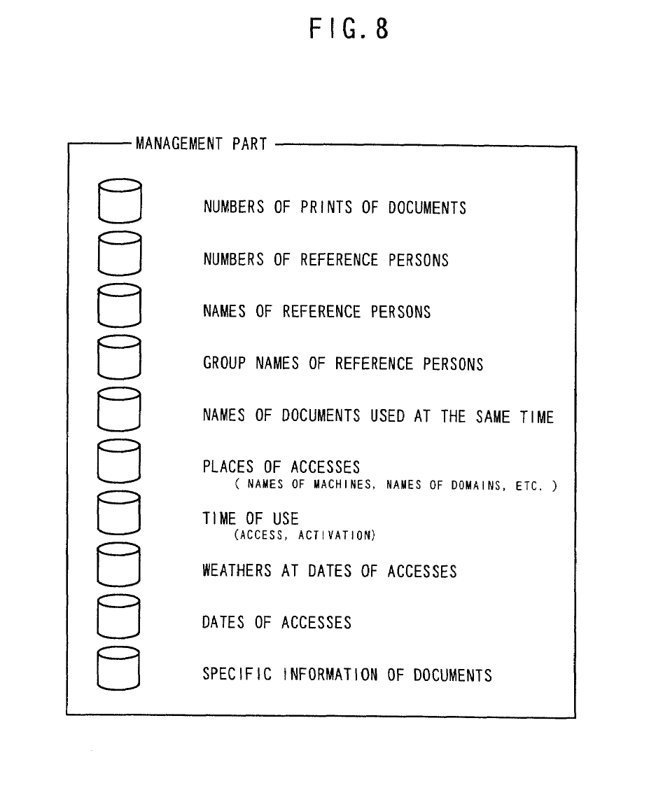

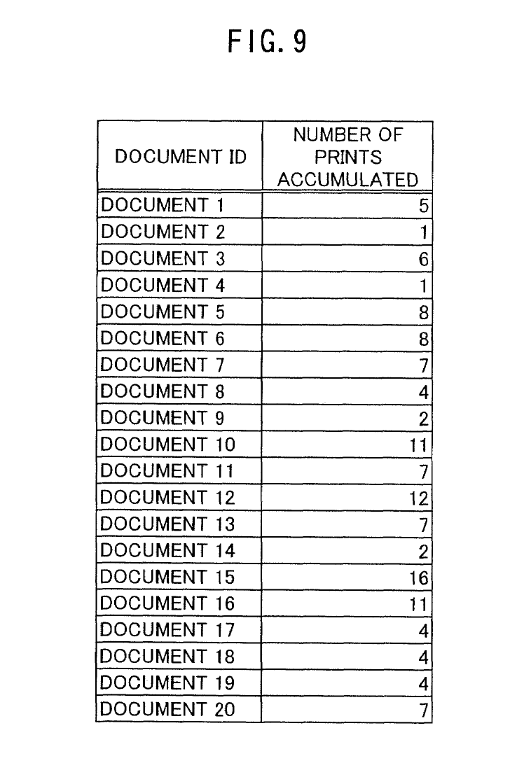

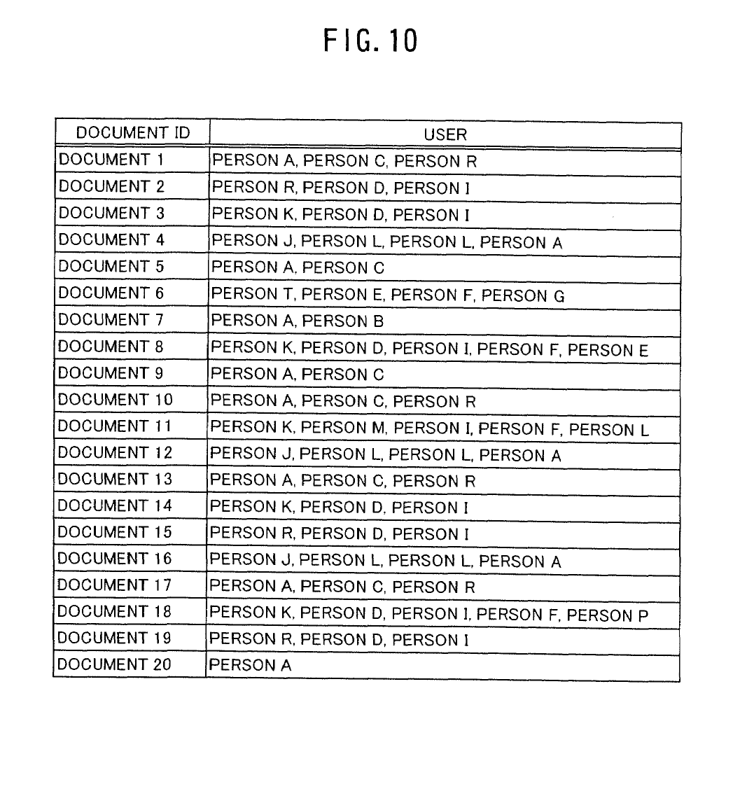

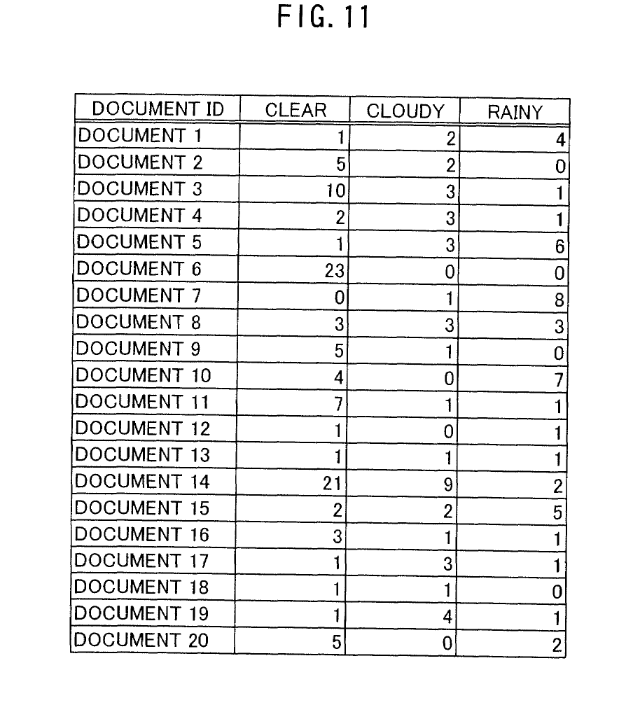

In addition, in the management part 14, the results of analyses on the individual pieces of information are stored in easily reusable form. For example, the easily reusable form means that analysis results are managed in separate tables in accordance with the kinds of relevant information, the usage of requests, etc. Additionally, it is in such a form that information is not collected and analyzed each time a request for information is made from the information request part 11, but instead pieces of information for requests are analyzed and stored in advance, so that it is possible to reply to a request from the request part in an efficient and quick manner. For information storage form, in case where individual pieces of information are recorded in separate tables, respectively, for example, a table concerning the number of prints of each document, the user of each document, the weather when each document is accessed, and so on are held (FIG. 8), and a document number, which is a specific piece of information, is attached to each document, so that the current state of each document is then recorded, updated and managed. Examples of such a data table in the management part are illustrated in FIG. 9, FIG. 10 and FIG. 11.

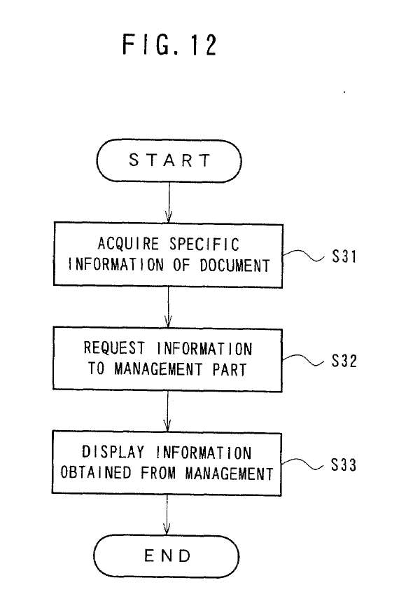

On the other hand, the user or the system in the document using part 3, wanting to acquire the information (management information) managed with respect to a specific document, can obtain that information by means of the information request part 11. The flow of operation until the information request part 11 acquires the information will be described below by using a flow chart in FIG. 12.

The information request part 11 acquires the specific information of the document (S31), and requests, based thereon, necessary information to the management part 14 (S32), so that the result of the information acquired from the management part 14 is displayed in the document using part or another place (S33). Alternatively, it can also be output.

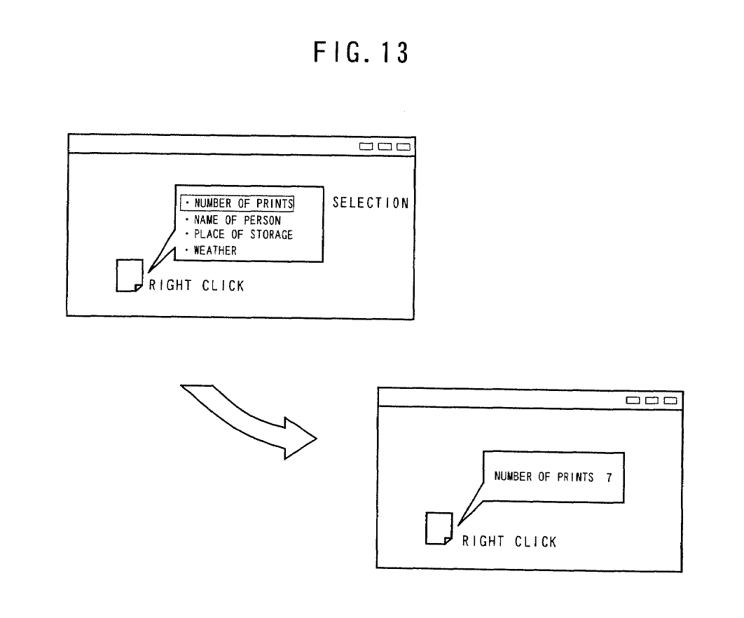

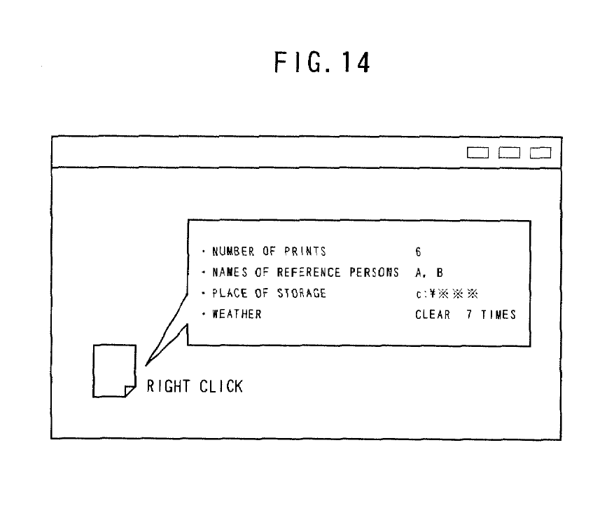

FIG. 13 and FIG. 14 illustrate concrete examples of a method of requesting management information. By right clicking a certain document displayed on the display section 4 in the document using part 3, the information request part 11 makes an inquiry to the management part 14, so that a list of the names of available pieces of relevant information (table names) related to that document is displayed (e.g., “the number of prints”, “the person's name”, “the place in which the document is stored”, etc., in FIG. 13).

Then, by selecting a certain piece of relevant information from the list (e.g., “the number of prints” in FIG. 13), the request part again makes an inquiry to the management part so that the state (value) of the relevant information is displayed (“the number of prints: 7” in FIG. 13). Also, the names of available pieces of attribute information (table names) and their contents can be displayed in a list at the same time (FIG. 14).

Although in this embodiment, reference has been made to the case where the operations illustrated in FIG. 1, FIG. 4, FIG. 6 and FIG. 12 are executed by a computer based on a program stored in a recording medium installed in the first document information management apparatus, and the operation illustrated in FIG. 7 is executed by a computer based on a program stored in a recording medium installed in the second document information management apparatus, the present invention is not limited to such a case where these programs are stored in the document information management apparatuses, but instead similar functions can be downloaded into the apparatuses via a network, or a recording medium storing therein similar functions can be installed on the apparatuses. In this regard, note that the recording mediums can be of any form, such as for example a CD-ROM, which is able to store programs and which is able to be read out by the apparatuses. In addition, the functions to be obtained by such preinstallation or downloading can be achieved through cooperation with an OS (operating system) or the like in the interior of each apparatus.

As described in detail in the foregoing, according to the above embodiment of the present invention, the relevant information desired by a user can be acquired, and additionally, the information, which is created from the thus acquired relevant information and which is desired by the user, can be obtained in an efficient and quick manner.

What is claimed:

1. A document information management apparatus for acquiring information related to a document to manage it as document information, said apparatus comprising:
a transmission relevant information acquisition part that acquires information related to a document sent from an apparatus handling said document; and
a relevant information analysis part that analyzes the information related to said document acquired by said transmission relevant information acquisition part at prescribed timing related to the timing at which said information is acquired based on said information.

2. The document information management apparatus as set forth in claim 1, further comprising an analysis result management part that manages the result of the analysis made in said relevant information analysis part.

3. The document information management apparatus as set forth in claim 2, characterized in that said relevant information analysis part analyzes the information acquired by said transmission relevant information acquisition part by using the analysis result managed in said analysis result management part.

4. A computer readable medium adapted to be executed by a computer of a document information management apparatus for acquiring and managing information related to a document,
said program serving to make said computer perform:
a transmission relevant information acquisition step of acquiring information related to a document sent from an apparatus handling said document; and
a relevant information analysis step of analyzing the information related to said document acquired in said transmission relevant information acquisition step at prescribed timing related to the timing at which said information is acquired.

5. The computer readable medium as set forth in claim 4, wherein said program comprises an analysis result management step of managing the result of the analysis made in said relevant information analysis step, said program serving to make said computer perform said analysis result management step.

6. The computer readable medium as set forth in claim 5, wherein said relevant information analysis step analyzes the information acquired in said transmission relevant information acquisition step by using the analysis result managed in said analysis result management step.

7. A method for acquiring and managing information related to a document, comprising:
acquiring information related to a document sent from an apparatus that is handling said document; and
analyzing the acquired information related to said document at a prescribed timing that is related to a timing at which said information is acquired.

8. The method as set forth in claim 7, further comprising:
managing the result of the acquired information that has been analyzed.

9. The method as set forth in claim 8, wherein the acquired information is analyzed using the result of the acquired information that has been managed.
